(19) United States
(12) Patent Application Publication
(10) Pub. No.: US 2007/0250567 A1
(43) Pub. Date: Oct. 25, 2007

(54) System and method for controlling a telepresence system

(76) Inventors: Philip R. Graham, Milpitas, CA (US); David J. Mackie, Brookdale, CA (US); Kristin A. Dunn, Livermore, CA (US); Kenneth Erion, Sheridan, OR (US)

Correspondence Address: BAKER BOTTS L.L.P., 2001 ROSS AVENUE, SUITE 600, DALLAS, TX, 75201-2980, US

(21) Appl. No.: 11/483,796

(22) Filed: Jul. 10, 2006

Related U.S. Application Data
(60) Provisional application No. 60/794,016, filed on Apr. 20, 2006.

(51) Int. Cl. G06F 15/16; H04L 12/16; H04Q 11/00

(52) U.S. Cl. 709/204; 370/260

(57) ABSTRACT

A system for controlling a telepresence system includes a plurality of visual conferencing components operable to host a visual conference. The system also includes a controller coupled to the visual conferencing components. The system further includes an internet protocol (IP) phone coupled to the controller and operable to display a user interface comprising a plurality of options. The IP phone is also operable to receive input from a user and to relay the input to the controller. The controller is operable to control the visual conferencing components in accordance with the input from the IP phone.

### RELATED APPLICATIONS

This application claims priority to U.S. patent application Ser. No. 60/794,016, entitled “VIDEOCONFERENCING SYSTEM,” which was filed on Apr. 20, 2006.

### TECHNICAL FIELD OF THE INVENTION

This invention relates generally to communications and, more particularly, to a system and method for controlling a telepresence system.

### BACKGROUND

As the “global economy” continues to expand, so does the need to be able to communicate over potentially long distances with other people. One area of communication that has seen steady growth and increased customer confidence is the use of the internet and other networking topographies. With the constant growth and development of networking capabilities has come the ability to implement more and better products and features. One area in particular that has seen growth and development in both quantity and quality is the area of internet enabled phone calls, using for example VoIP. By taking audio signals (the speaker's voice) and converting them into internet protocol (IP) packets, IP phones are able to send the audio signals over IP networks, such as the internet.

Unfortunately, there are times when voice communication alone is not sufficient. In such instances video conferencing may be an attractive and viable alternative. Current video conferencing often involves complicated setup and call establishment procedures (usually requiring someone from technical support to setup the equipment prior to the conference). Once the conference has begun making adjustments can be similarly complicated. Furthermore, where there are multiple users the typical video conferencing system divides a single screen into different sections. Each section is usually associated with a particular location, and all the users at that location need to try to fit within the camera's field of vision. Current video conferencing systems also typically use a single speaker, or speaker pair, for reproducing the sound. Thus, regardless of who is speaking the sound comes from the same location. This often requires the receiving user to carefully scan the screen, examining each user individually, to determine who is speaking. This can be especially difficult in a video conference in which the screen is divided among several locations, and each location has multiple users within the camera's field of vision.

### SUMMARY

In accordance with particular embodiments, a system and method for controlling a telepresence system is provided which substantially eliminates or reduces the disadvantages and problems associated with previous systems and methods.

In accordance with a particular embodiment, a system for controlling a telepresence system includes a plurality of visual conferencing components operable to host a visual conference. The system also includes a controller coupled to the visual conferencing components. The system further includes an internet protocol (IP) phone coupled to the controller and operable to display a user interface comprising a plurality of options. The IP phone is also operable to receive input from a user and to relay the input to the controller. The controller is operable to control the visual conferencing components in accordance with the input from the IP phone.

The input may include any of the following: a request to establish an audio communication session with a remote endpoint using the IP phone during the visual conference; a request to establish a subsequent video communication session with a remote endpoint using the IP phone during the visual conference; a request to include video in an audio communication session; a request to answer an incoming request for an audio communication session during the visual conference; a request to answer an incoming request for a video communication session during the visual conference; a request to prevent an incoming request for a communication session from being connected during the visual conference; a request to control which display of a plurality of displays will display video and which display of the plurality of displays will display data; or a request to select an auxiliary input from a plurality of auxiliary inputs for receiving visual conferencing component input.

Technical advantages of particular embodiments include providing users of a telepresence system with a simple user interface via an IP phone. Accordingly, users may feel comfortable setting up a visual conference using the IP phone. Another technical advantage of particular embodiments may include using the same IP phone to control the telepresence system to conduct one or more of the following communication sessions: a standard telephone call, a standard audio-only conference, a standard video conference, or a telepresence system enhanced visual conference. Accordingly, the interface may facilitate numerous different types of communication sessions via a single interface.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

To provide a more complete understanding of particular embodiments of the present invention and the features and advantages thereof, reference is made to the following description, taken in conjunction with the accompanying drawings, in which:

FIG. 1 illustrates a block diagram illustrating a system for conducting a visual conference between locations using at least one telepresence system, in accordance with a particular embodiment of the present invention;

FIG. 2 illustrates a perspective view of a local exemplary telepresence system including portions of a remote telepresence system as viewed through local monitors, in accordance with a particular embodiment of the present invention; and

FIG. 3 illustrates a block diagram illustrating a system for controlling a telepresence system, in accordance with a particular embodiment of the present invention.

### DESCRIPTION OF EXAMPLE EMBODIMENTS

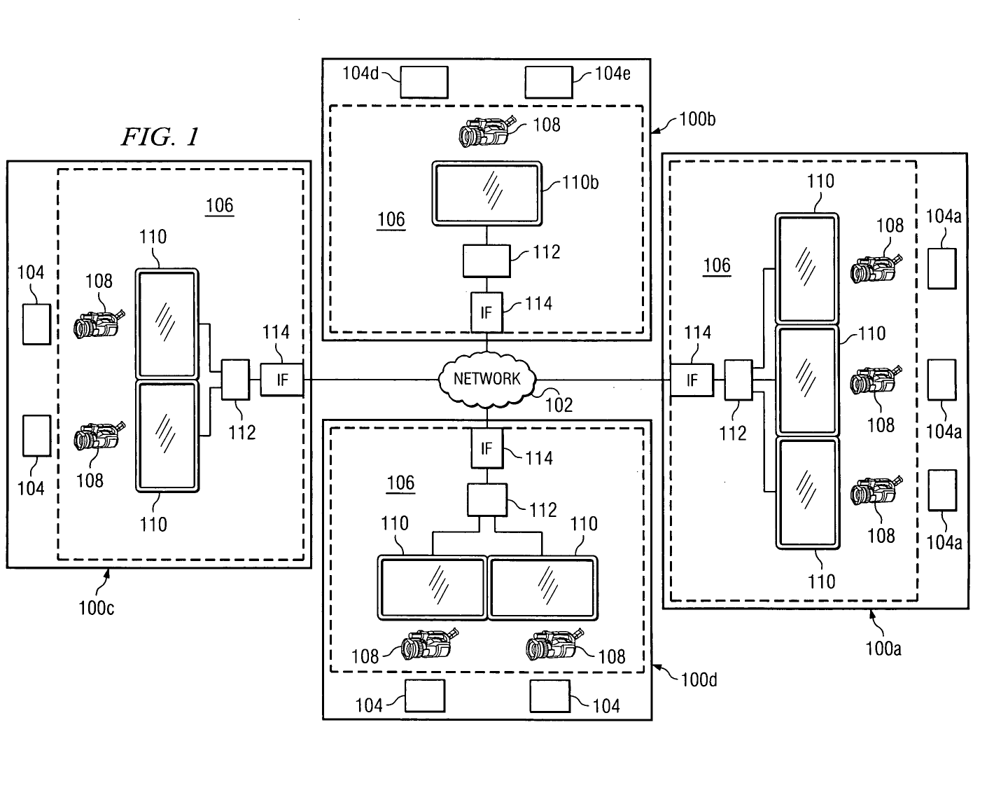

FIG. 1 is a block diagram illustrating a system 10 for conducting a visual conference between locations using at least one telepresence system. The illustrated embodiment includes a network 102 that facilitates a visual conference between remotely located sites 100 using telepresence equipment 106. Sites 100 include any suitable number of users 104 that participate in the visual conference. System 10 provides users 104 with a realistic videoconferencing experience even though a local site 100 may have less telepresence equipment 106 than remote site 100.

Network 102 represents communication equipment, including hardware and any appropriate controlling logic, for interconnecting elements coupled to network 102 and facilitating communication between sites 100. Network 102 may include a local area network (LAN), a metropolitan area network (MAN), a wide area network (WAN), any other public or private network, a local, regional, or global communication network, an enterprise intranet, other suitable wireline or wireless communication link, or any combination of the preceding. Network 102 may include any combination of gateways, routers, hubs, switches, access points, base stations, and any other hardware, software, or a combination of the preceding that may implement any suitable protocol or communication.

User 104 represents one or more individuals or groups of individuals who are present for the visual conference. Users 104 participate in the visual conference using any suitable device and/or component, such as an audio Internet Protocol (IP) phones, video phone appliances, personal computer (PC) based video phones, and streaming clients. During the visual conference, users 104 engage in the session as speakers or participate as non-speakers.

Telepresence equipment 106 facilitates the videoconferencing among users 104. Telepresence equipment 106 may include any suitable elements to establish and facilitate the visual conference. For example, telepresence equipment 106 may include speakers, microphones, or a speakerphone. In the illustrated embodiment, telepresence equipment 106 includes cameras 108, monitors 110, processor 112, and network interface 114.

Cameras 108 include any suitable hardware and/or software to facilitate both capturing an image of user 104 and her surrounding area as well as providing the image to other users 104. Cameras 108 capture and transmit the image of user 104 as a video signal (e.g., a high definition video signal). Monitors 110 include any suitable hardware and/or software to facilitate receiving the video signal and displaying the image of user 104 to other users 104. For example, monitors 110 may include a notebook PC or a wall mounted display. Monitors 110 display the image of user 104 using any suitable technology that provides a realistic image, such as high definition, high-power compression hardware, and efficient encoding/decoding standards. Telepresence equipment 106 establishes the visual conference session using any suitable technology and/or protocol, such as Session Initiation Protocol (SIP) or H.323. Additionally, telepresence equipment 106 may support and be interoperable with other video systems supporting other standards, such as H.261, H.263, and/or H.264.

Processor 112 controls the operation and administration of telepresence equipment 106 by processing information and signals received from cameras 108 and interfaces 114. Processor 112 includes any suitable hardware, software, or both that operate to control and process signals. For example, processor 112 may be a programmable logic device, a microcontroller, a microprocessor, any suitable processing device, or any combination of the preceding. Interface 114 communicates information and signals to and receives information and signals from network 102. Interface 114 represents any port or connection, real or virtual, including any suitable hardware and/or software that may allow telepresence equipment 106 to exchange information and signals with network 102, other telepresence equipment 106, or and/or other elements of system 10.

In an example embodiment of operation, users 104 may control via an IP phone the operation and settings of cameras 108, monitors 110 and numerous other components and devices that may comprise telepresence equipment 106. The IP phone may send instructions received from user 104 to processor 112 informing processor 112 what components of telepresence equipment 106 should be activated and how they should be set-up. Depending on the type of communication session that is desired, this may involve the processor activating and/or configuring all or some of the components within telepresence equipment 106.

Modifications, additions, or omissions may be made to system 10. For example, system 10 may include any suitable number of sites 100 and may facilitate a visual conference between any suitable number of sites 100. As another example, sites 100 may include any suitable number of cameras 108 and monitors 110 to facilitate a visual conference. As yet another example, the visual conference between sites 100 may be point-to-point conferences or multipoint conferences. Moreover, the operations of system 10 may be performed by more, fewer, or other components. Additionally, operations of system 10 may be performed using any suitable logic.

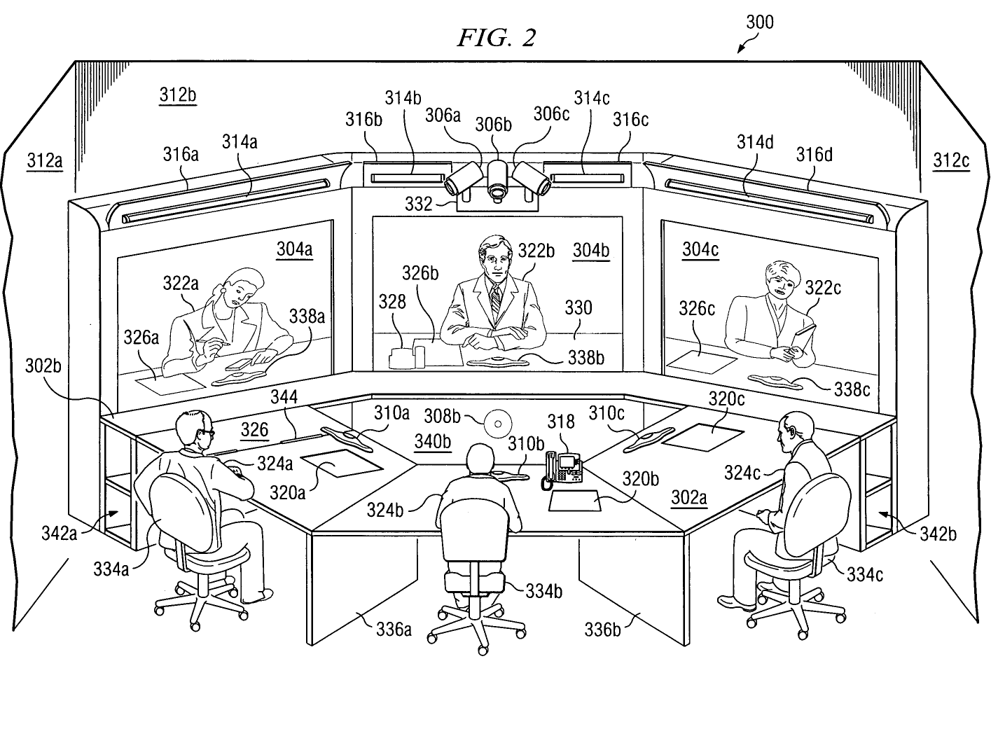

FIG. 2 illustrates a perspective view of a local exemplary telepresence system including portions of a remote telepresence system as viewed through local monitors. Telepresence system 300 may be similar to system 10 of FIG. 1. Telepresence system 300 provides for a high-quality visual conferencing experience that surpasses typical video conference systems. Through telepresence system 300 users may experience lifelike, fully proportional (or nearly fully proportional) images in a high definition (HD) virtual table environment. The HD virtual table environment, created by telepresence system 300, may help to develop an in-person feel to a visual conference. The in-person feel may be developed not only by near life-sized proportional images, but also by the exceptional eye contact, gaze perspective (hereinafter, “eye gaze”), and location specific sound. The eye gaze may be achieved through the positioning and aligning of the users, the cameras and the monitors. The location specific sound may be realized through the use of individual microphones located in particular areas that are each associated with one or more speakers located in proximity to the monitor displaying the area in which the microphone is located. This may allow discrete voice reproduction for each user or group of users.

Telepresence system 300 may also include a processor to control the operation and administration of the components of the system by processing information and signals received from such components. The processor may include any suitable hardware, software, or both that operate to control and process signals. For example, the processor may be a programmable logic device, a microcontroller, a microprocessor, any suitable processing device, or any combination of the preceding. Through its operation, the processor may facilitate the accurate production of the eye-gaze functionality as well as the location specific sound features discussed herein.

The design of telepresence system 300 is not limited to only those components used in typical video conferencing systems, such as monitors 304, cameras 306, speakers 308, and microphones 310, rather it may encompass many other aspects, features, components and/or devices within the room, including such components as table 302, walls 312, lighting (e.g., 314 and 316) and several other components discussed in more detail below. These components may be designed to help mask the technology involved in telepresence system 300, thus decreasing the sense of being involved in a video conference while increasing the sense of communicating in person. Telepresence system 300, as depicted in FIG. 2, may also include several users both local, users 324a-324c, and remote, users 322a-322c.

The eye gaze and the location specific sound features may combine to produce a very natural dialogue between local and remote users. When, for example, remote user 322a speaks, his voice is reproduced through speaker 308a located underneath monitor 304a, the monitor on which remote user 322a is displayed. Local users 324 may naturally turn their attention towards the sound and thus may be able to quickly focus their attention on remote user 322a. Furthermore, if remote user 322a is looking at something or someone, the exceptional eye gaze capabilities of telepresence system 300 may allow local users 324 to easily identify where he is looking. For example, if remote user 322a asks “what do you think” while looking at local user 324c, the eye gaze ability of telepresence system 300 may allow all the users, both local and remote, to quickly identify who “you” is because it may be clear that remote user 322a is looking at local user 324c. This natural flow may help to place the users at ease and may contribute to the in-person feel of a telepresence assisted visual conferencing experience.

Several of the figures discussed herein depict not only components of the local telepresence system, but also those components of a remote telepresence system that are within the field of vision of a remote camera and displayed on a local monitor. For simplicity, components located at the remote site will be preceded by the word remote. For example, the telepresence system at the other end of the visual conference may be referred to as the remote telepresence system. When a component of the remote telepresence system can be seen in one of monitors 304 it may have its own reference number, but where a component is not visible it may use the reference number of the local counterpart preceded by the word remote. For example, the remote counterpart for microphone 310a may be referred to as remote microphone 338a, while the remote counterpart for speaker 308b may be referred to as remote speaker 308b. This may not be done where the location of the component being referred to is clear.

Part of the in-person experience may be achieved by the fact that the telepresence system may include many of the features and/or components of a room. In some embodiments the rooms at both ends of the conference may be similar, if not identical, in appearance because of the use of telepresence system 300. Thus, when local users 324 look into monitors 304 they are confronted with an image having, in the background, a room that appears to match their own room. For example, walls 312 of telepresence system 300 may have similar colors, patterns, and/or structural accents or features as the remote walls 312 of the remote telepresence system.

Another aspect of telepresence system 300 that lends itself to creating an in-person experience is the configuration of table 302, remote table 330, monitors 304 and remote cameras 306. These components are positioned in concert with one another such that it appears that table 302 continues through monitor 304 and into table 330, forming a single continuous table, instead of two separate tables at two separate locations. More specifically, table 302 may include a full sized table front section 302a that may be slightly curved and/or angled. Table front section 302a may be coupled to table rear section 302b which may continue from table front section 302a. However, table rear section 302b may have a shortened width. The shortened width of rear section 302 may be such that when it is juxtaposed with the portion of remote table 330 displayed in monitors 304, the two portions appear to be a portion of the table having a full width similar to table front section 302a.

Besides the placement of remote table 330, the placement and alignment of remote cameras 306 may be such that the correct portion of table 330 is within remote cameras 306 field of vision as well as the user or group of users that may be sitting at that portion of table 330. More specifically, remote camera 306a may be aligned to capture the outer left portion of table 330 and remote user 324a, remote camera 306b may be aligned to capture the outer center portion of table 330 and remote user 324b and remote camera 306c may be aligned to capture the outer right portion of table 330 and user remote 324c. Each camera 306 and remote camera 306 may be capable of capturing video in high-definition, for example cameras 306 may capture video at 720i, 720p, 1080i, 1080p or other higher resolutions. It should be noted that where multiple users are within a cameras field of vision the alignment of the camera does not need to be changed.

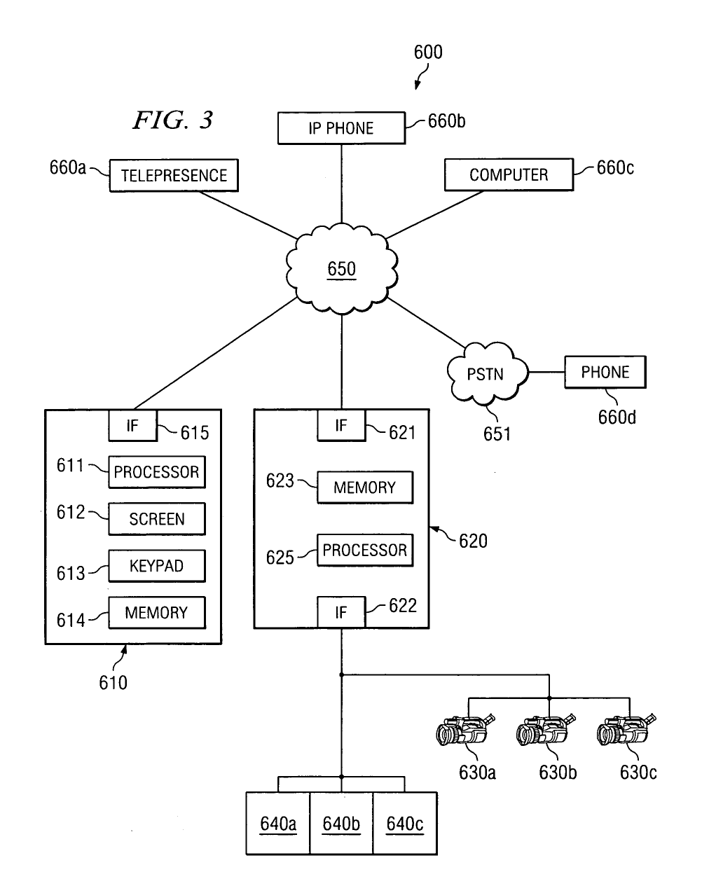

In some embodiments remote cameras 306 may be aligned so that any horizontal gap between the adjacent vertical edges of the field of vision between two adjacent cameras corresponds to any gap between the screens of monitors 304 (the gap between monitors may include any border around the screen of the monitor as well as any space between the two monitors). For example, the horizontal gap between the adjacent vertical edges of remote camera 306a and 306b, may align with the gap between the screens of monitors 304a and 304b (e.g., gaps d2 and d3 of FIG. 3). Furthermore, remote cameras 306 and monitors 304 may be aligned so that objects that span the field of vision of multiple cameras do not appear disjointed (e.g., the line where the remote wall meets the remote ceiling may appear straight, as opposed to being at one angle in one monitor and a different angle in the adjacent monitor). Thus, if remote user 322a were to reach across to touch, for example, computer monitor 326b, users 324 may not see abnormal discontinuities (e.g., abnormally long, short or disjointed) in remote user 322's arm as it spans across monitors 304a and 304b (and the field of vision of remote cameras 306a and 306b).

In some embodiments monitors 330 may be capable of displaying the high-definition video captured by remote cameras 306. For example, monitors 330 may be capable of displaying video at 720i, 720p, 1080i, 1080p or another high resolution. In some embodiments monitors 304 may be flat panel displays such as LCD monitors or plasma monitors. In particular embodiments monitors 304 may have 60 inch screens (measured diagonally across the screen). The large screen size may allow telepresence system 300 to display remote users 322 as proportional and life-sized (or near proportional and near life-sized) images. The high-definition display capabilities and large screen size of monitors 304 may further add to the in-person effect created by telepresence system 300 by increasing the size of the video image while also maintaining a clear picture (avoids pixelation or blurring that may result from attempting to display a standard definition image on a large monitor).

In some embodiments, monitors 304 may be positioned so that they form an angled wall around table rear section 302b. In particular embodiments, monitors 304 may be aligned such that their arrangement approximately mirrors the outside edge of table front section 302a. More specifically, monitor 304b may be parallel to wall 312b, while monitors 304a and 304c may be angled in towards user 324b and away from wall 312b. While monitors 304a and 304c are angled (compared to monitor 304b), the inside vertical edge of each monitor (the rightmost edge of monitor 304a and the leftmost edge of monitor 304c) may abut or nearly abut the left and right sides, respectively, of monitor 304b. Similarly, the bottom edge of monitors 304b may abut or nearly abut the back edge of back section 302b. In particular embodiments monitors 304 may be positioned so that the bottom border or frame of monitor 304 is below the top surface of back section 302b and thus is not visible to users 324. This may provide for an apparent seamless transition from local table 302 to remote table 330 as displayed on monitors 304.

In some embodiments, monitors 304 and remote cameras 306 may further be aligned to increase the accuracy and efficacy of the eye gaze of remote users 322. For example, in particular embodiments, remote cameras 306 may be located 4 to 6 inches below the top of remote monitor 304a. Thus, when remote users 322 are involved in a telepresence session with local users 324 it may appear that remote users 322 are looking at local users 324. More specifically, the images of remote users 322 may appear on monitor 304 to be creating/establishing eye-contact with local users 324 even though remote users 322 are in a separate location. As may be apparent, increasing the accuracy of the eye gaze increases the in-person feel of a visual conference hosted via telepresence system 300.

Depending on the embodiment, cameras 306 may be freely movable, not readily moveable (e.g., they may require some tools to adjust them), or fixed. For example, in particular embodiments in which cameras 306 are not readily moveable, it may still be possible to fine tune the alignment of cameras 306 to the left or right, up or down, or rotationally. In some embodiments it may be desirable to not have to adjust cameras 306 each time telepresence system 300 is used because doing so may decrease the simplicity of using telepresence system 300. Thus, it may be advantageous to limit the area in which a user may sit when interfacing with telepresence system 300. One such component of telepresence system 300 that may be used to help control where users sit in relation to the cameras may be the table. Users 324 may sit along the outside edge of table front section 302a to be able to take notes, rest their elbows or otherwise use table 302. This may allow the depth of field and zoom of cameras 306 to be set based on the size of table 302. For example, in some embodiments the depth of field of cameras 306 may be set so that if users 324 are between two feet in front of and four feet behind the outside edge of table front section 302a, they may be in focus. Similarly, the zoom of cameras 306 may be set so that users sitting at the table will appear life-sized when displayed in remote monitors. As should be apparent, the amount of zoom may not only depend on distance between cameras 306 and users 324, but also the screen size of remote monitors 304.

Besides keeping users 324 within the focus range of cameras 306 it may also be desirable to keep them within the field of vision of cameras 306. In some embodiments, dividers 336 may be used to limit users 324's lateral movement along/around the outside edge of table front section 302a. The area between dividers 336 may correspond to the field of vision of the respective cameras 306, and may be referred to as a user section. Having dividers to restrict lateral movement along table 302 may be particularly important where there are multiple users within a camera's field of vision. This may be so because with multiple users within a particular camera's field of vision it may be more likely that the multiple users will need more lateral space along table 302 (as opposed to a single user). Therefore, the dividers may help to prevent the multiple users from inadvertently placing themselves, in whole or in part, outside of the field of vision.

Dividers 336 may be shaped and sized such that a user would find it uncomfortable to be right next to, straddling, behind or otherwise too close to dividers 336. For example, in particular embodiments dividers 336 may be large protrusions covered in a soft foam that may extend along the bottom surface of table front section 302 up to or beyond the outside edge of table front section 302a. In particular embodiments, dividers 336 may be used in supporting table 302 or they may be added to certain components of the support structure of table 302. Using dividers 336 as part of the support structure of table 302 may increase the amount of foot/leg room for users 324 under table 302. Different embodiments may use different dividers or other components or features to achieve the same purpose and may provide additional or alternate functionality as discussed in more detail below.

In some embodiments, table 302 may include other features that may help guide a user to a particular area (e.g., the center of cameras 306's field of vision) of table 302, or that may help prevent a user from straying out of a particular area and thus into the fields of vision of multiple cameras or out of the field of vision of a particular camera. For example, table 302 may include computer monitors 320, which may be used to display information from a computer (local or remote), such as a slide-show or a chart or graph. Computer monitors 320 may include CRT, LCD or any other type of monitor cable of displaying images from a computer. In some embodiments computer monitors 320 may be integrated into table 302 (e.g., the screen of computer monitors 320 may be viewed by looking down onto the table top of table 302) while in other embodiments they may be on the surface (e.g., the way a traditional computer monitor may rest on a desk). In particular embodiments, computer monitors 320 may not be a part of table 302, but rather they may be separate from table 302. For example they may be on a movable cart. Furthermore, some embodiments may use a combination of integrated, desktop and separate monitors.

Another feature of table 302 that may be used to draw users 324 to a particular area may be microphone 310. In particular embodiments, microphone 310 may be integrated into table 302, thereby reducing a user's ability to move it, or it may be freely movable, thereby allowing it be repositioned if more than one user is trying to use the same microphone. In some embodiments microphones 310 may be directional microphones having a cardioid, hypercardioid, or other higher order directional patterns. In particular embodiments microphones 310 may be low profile microphones that may be mounted close to the surface of table 302 so as to reduce the effect of any echo or reflection of sound off of table 302. In some embodiments microphones 310 may be linked such that when multiple microphones, for example microphones 310a and 310b, detect the same sound, the detected sound is removed via, for example, filtering from the microphone at which the detected sound is weakest. Thus, it may be that the sound from a particular user may primarily be associated with the microphone closest to the speaking user.

Some embodiments may take advantage of being able to have sound coming from a single source (e.g., microphone 310a) having a known location (e.g., the left side of table 302) by enabling location specific sound. Telepresence system 300 may reproduce the sound detected by a particular microphone with a known location through a speaker in proximity to the monitor that is displaying the area around the particular microphone that detected the sound. Thus, sound originating on the left side of remote telepresence system 300 may be reproduced on the left side of telepresence system 300. This may further enhance the in-person effect by reproducing the words of a remote user at the speaker near the monitor on which that speaker is displayed. More specifically, if remote user 322a speaks, it may be that both remote microphones 338a and 338b may detect the words spoken by user 322a. Because user 322a is closer to microphone 338a and because microphone 338a is oriented towards user 322a, it may be that the signal of user 322a's voice is stronger at microphone 338a. Thus, the remote telepresence system may ignore/filter the input from microphone 338b that matches the input from microphone 338a. Then, it may be that speaker 308a, the speaker under monitor 304a, reproduces the sound detected by microphone 338a. When user's 324 hear sound coming from speaker 308a they may turn that way, much like they would if user 322a were in the same room and had just spoken.

In particular embodiments, speakers 308 may be mounted below, above or behind monitors 308, or they may otherwise be located in proximity to monitors 308 so that when, for example, speaker 308b reproduces words spoken by remote user 322b, users 324 may be able to quickly identify that the sound came from remote user 322b displayed in monitor 304b. In addition to speakers 308, some embodiments of telepresence system 300 may include one or more additional auxiliary speakers. The auxiliary speakers may be used patch in a remote user who may not have access to a telepresence system or any type of video conferencing hardware. While speakers 308 (or portions thereof) are clearly visible in FIG. 4, in some embodiments speakers 308 may visibly be obscured by a sound-transparent screen or other component. The screen may be similar in material to the sound-transparent screen used on many consumer loud-speakers (e.g., a fabric or metal grill). To help reduce the indication that telepresence system 300 includes speakers 308, the sound-transparent screen may cover the entire area under monitors 304. For example, speaker area 340 (including speaker 308b) may be covered in the sound-transparent material.

As may be ascertained from the preceding description, each remote user 322 may have associated with them a monitor, a remote camera, a remote microphone, and/or a speaker. For example remote user 322c may have associated with him monitor 304c, remote camera 306c, remote microphone 338c, and/or speaker 308c. More specifically, remote camera 306c may be trained on the user section in which user 322c is seated so that his image is displayed on monitor 304c and when he speaks microphone 338c may detect his words which are then played back via speaker 308c while users 324 watch and listen to user 322c. Thus, from the perspective of local users 324 the telepresence system 300 assisted visual conference may be conducted as though remote user 324c was in the room with local users 324.

Another feature of some embodiments is the use of lighting that may be designed/calibrated in concert with remote cameras 306 and monitors 304 to enhance the image displayed by monitors 304 so that the colors of the image of remote users 322 displayed on monitors 304 more closely approximate the actual colors of remote users 322. The lighting may be such that its color/temperature helps to compensate for any discrepancies that may be inherent in the color captured by remote cameras 306 and/or reproduced by monitors 304. For example, in some embodiments the lighting may be controlled to be around 4100 to 5000 Kelvin.

Particular embodiments may not only control the color/temperature of the lights, but may also dictate the placement. For example, there may be lighting placed above the heads of remote users 322 to help reduce any shadows located thereon. This may be particularly important where remote cameras 306 are at a higher elevation than the tops of remote users 322's heads. There may also be lighting placed behind remote cameras 306 so that the front of users 322 is properly illuminated. In particular embodiments, lights 314 may be mounted behind, and lower than the top edge of, monitors 304. In some embodiments, reflectors 316 may be positioned behind monitors 304 and lights 314 and may extend out beyond the outside perimeter of monitors 304. In some embodiments the portion of reflectors 316 that extends beyond monitors 304 may have a curve or arch to it, or may otherwise be angled, so that the light is reflected off of reflectors 316 and towards users 324. In particular embodiments filters may used to filter the light being generated from behind cameras 306. Both the reflectors and filters may be such that remote users are washed in a sufficient amount of light (e.g., 300-500 luxes) while reducing the level of intrusiveness of the light (e.g., having bright spots of light that may cause remote user 324 to squint). Furthermore, some embodiments may include a low gloss surface on table 302. The low gloss surface may reduce the amount of glare and reflected light caused by table 302.

While telepresence system 300 may include several features designed to increase the in-person feel of a visual conference using two or more telepresence systems 300, telepresence system 300 may also include other features that do not directly contribute to the in-person feel of the conference but which nonetheless may contribute to the general functionality of telepresence system 300. For example, telepresence system 300 may include one or more cabinets 342. Cabinets 342 may provide support for table 302, and they may provide a convenient storage location that is not within the field of vision of cameras 306. In some embodiments cabinets 342 may include doors.

Another attribute of some embodiments may be access door 326. Access door 326 may be a portion of table 302 that includes hinges 344 at one end while the other end remains free. Thus, if a user wants to get into the open middle portion of table 302 (e.g., to adjust cameras 306, clean monitors 304, or pick something up that may have fallen off of table 302) he may be able to easily do so by lifting the free end of access door 326. This creates a clear path through table 302 and into the middle portion of table 302.

Another attribute of some embodiments may be the inclusion of power outlets or network access ports or outlets. These outlets or ports may be located on top of table 302, within dividers 336 or anywhere else that may be convenient or practical.

What may be missing from particular embodiments of telepresence system 300 is a large number of remotes or complicated control panels, as seen in typical high-end video conference systems. Rather, much of the functionality of telepresence system 300 may be controlled from a single phone, such as IP phone 318 (e.g., Cisco's 7970 series IP phone). By placing the controls for telepresence system 300 within an IP phone user 324 is presented with an interface with which he may already be familiar. This may minimize the amount of frustration and confusion involved in setting up a visual conference and/or in operating telepresence system 300.

IP phone 318 may allow a user to control telepresence system 300 and its various components by providing the user with a series of display screens featuring various options. These options may be associated with a respective soft key that, when pressed, may either cause one of the components of telepresence system 300 to perform some task or function, or it may cause IP phone 318 to display a subsequent display screen featuring additional options or requests. Thus a user is presented with a graphical interface integrated into a phone. The interface masks the advanced technology of telepresence system 300 behind the simple-to-use graphical interface.

Furthermore, in particular embodiments various components of telepresence system 300 may be used to conduct normal video conferences (where the remote site does not have a telepresence system available) or standard telephone calls. For example, user 324b may use IP phone 318 of telepresence system 300 to place a normal person-to-person phone call, or to conduct a typical audio conference call by activating microphones 310 and/or speakers 308 (or the auxiliary speaker, where applicable).

It will be recognized by those of ordinary skill in the art that the telepresence system depicted in FIG. 2, telepresence system 300, is merely one example embodiment of a telepresence system. The components depicted in FIG. 2 and described above may be replaced, modified or substituted to fit individual needs. For example, the size of the telepresence system may be reduced to fit in a smaller room, or it may use one, two, four or more sets of cameras, monitors, microphones, and speakers. Furthermore, while FIG. 2 only depicts a single user within each user section, it is within the scope of particular embodiments for there to be multiple users sitting within any given user section and thus within the field of vision of a camera and displayed on the monitor. As another example, monitors 304 may be replaced by blank screens for use with projectors.

FIG. 3 illustrates a block diagram of a telepresence system in accordance with particular embodiments. Telepresence system 600 includes IP phone 610, telepresence controller (TPC) 620, cameras 630, monitors 640 and network 650. Network 650 couples IP phone 610 to telepresence controller 620. Network 650 may be similar to network 102 of FIG. 1. Also coupled to network 650 may be any of a variety of other endpoints or networks including any hardware, software or logic operable to transmit data using packets. More specifically, depicted in FIG. 3 are endpoints 660, including telepresence system 660a, stand alone IP phone 660b, computer 660c, and phone 660d, which are merely some exemplary endpoints that may be coupled to network 650.

Phone 660d may be coupled to network 650 via public switched network 651 which may include switching stations, central offices, mobile telephone switching offices, pager switching offices, remote terminals, and other related telecommunications equipment that are located throughout the world. Between PSTN 651 and network 650 there may be a gateway which may allow PSTN 651 and network 650 to transmit data between each other even though they may be using different protocols. Network 650 may thus couple IP phone 610 to endpoints 660 such that they may participate in communication sessions with each other.

IP phone 610 may include processor 611, screen 612, keypad 613, and memory 614. From IP phone 610 a user may be able to input data or select menu options, displayed on screen 612, for controlling and/or interacting with monitors 640 and cameras 630 via TPC 620. While not depicted in FIG. 3, IP phone 610 and TPC 620 may work together to control any of the components of telepresence system 600, such as the lighting or the microphones. IP phone 610 may further provide a simple interface from which a user may initially set up telepresence system 600, initiate a visual conference, or any other type of communication session supported by IP phone 610. More specifically, interface 615 of IP phone 610 may couple IP phone 610 to TPC 620 such that the two devices may transmit communications between each other. These communications may include, but are not limited to, XML data sent from TPC 620 to IP phone 610 and telepresence commands sent from IP phone 610 to TPC 620. The XML data may contain information about one or more display screens to be displayed on screen 612 of IP phone 610. The display screens may present the user with options and choices for the user to select or activate during call set-up or during a communication session as well as provide the user with information about telepresence system 600, the remote caller, or the communication session. For example, just some of the possible display screens may include: one or more options on one or more screens; alerts or error messages about components of the telepresence system; caller ID information; or details about the current call such as duration. The options may include: a request to establish an audio communication session with a remote endpoint (e.g., place a call to phone 660d) using the IP phone during the visual conference; a request to establish a subsequent video communication session with a remote endpoint (e.g., initiate a video conference with computer 660c or a visual conference telepresence 660a) using the IP phone during the visual conference; a request to include video in an audio communication session; a request to answer an incoming request for an audio communication session (e.g., answering a call from phone 660d) during the visual conference; a request to answer an incoming request for a video communication session during the visual conference; a request to prevent an incoming request for a communication session from being connected (e.g., an “ignore” option) during the visual conference; a request to control which display of a plurality of displays will display video (e.g., the video of a remote user) and which display of the plurality of displays will display data (e.g., information such as caller ID or elapsed time); a request to select an auxiliary input from a plurality of auxiliary inputs for receiving visual conferencing component input (e.g., a slide show stored on a remote computer) during the visual conference; a request to change the volume; a request to control the dual tone muli-frequency (DTMF) tones during a call; a request to change what or who is displayed on a particular screen; a request to remove a remote user from an ongoing visual conference; a request to transfer between different call types (e.g., between a visual conference and an audio-only phone call); or any other request to change, alter or modify any aspect of telepresence system 600.

More specifically, if, for example, a user wants to place a call to phone 660d, the user may simply dial the corresponding phone number and then press a softkey indicated by screen 612 as being “Dial”. Upon pressing “Dial” IP phone may play the DTMF tones used by PSTN phones to attempt to connect IP phone 610 with the phone 660d. Similarly, if the local user is already involved in a communication session (using either IP phone 610 or telepresence system 600) with another user but wishes to establish a communication session with a second remote user, the local user may again use menu options displayed on screen 612 to attempt to establish the desired second communication session. More specifically, screen 612 may display “Hold” and when the associated softkey is pressed a new display screen may appear that has a “New Call” softkey. By pressing the “New Call” softkey the local user is able to place a call to phone 660d using similar keys as before when he placed the call to phone 660d. As a third example, if the local user in the previous example does not know the telephone number for endpoint 660d he may use a directory to look up the number. He may do so by, for example, pressing the “Hold” softkey and then pressing a “Directory” hardkey which may cause a directory to be displayed from which the local user may scroll through to the entry corresponding to endpoint 660d. The directory may be displayed on screen 612. In some embodiments the local user may be able to elect to have the directory displayed on one of monitors 640. Like other features of telepresence system 600, he may do so by selecting the appropriate menu options using the associated softkey.

Screen 612 may be a color screen capable of displaying color images related to the setup, control and/or operation of telepresence system 600. Based on the options presented by the display screen on screen 612, the user may use keypad 613 to select the desired option or to enter any particular information or data that they may want to enter. Keypad 613 may include several different keys, including, but not limited to, a set of 12 numeric keys (e.g., 0-9, # and *), one or more soft keys, and one or more dedicated function keys. Processor 611 may interpret the particular keystroke, or set of keystrokes, entered by the user and based on a combination of one or more of data within memory 614, the XML data received from TPC 620 and the particular key of keypad 613 that was pressed. For example, screen 611 may include an icon for a “New Call” softkey which the user may press and then dial the number associated with the endpoint to which the local user wishes to be connected. Before, or while, the user is entering the phone number screen 611 may change to include a new display screen that comprises options for the call, such as to have the current communication session be a visual conference using telepresence system 600. As another example, while the local user is involved in, for example, a standard audio-only conference call screen 612 may include several in-call options. One such option may be an option to place the call on hold. While the call is on hold the local user may press a “Telepresence” hardkey. Once the user presses the “Telepresence” hardkey, screen 612 may display a list of the ongoing calls. The local user may then scroll through the list until she finds the desired call to display via telepresence system 600.

Processor 611 may be a microprocessor, controller, or any other suitable computing device, resource, or combination of hardware, software and/or encoded logic. Memory 614 may be any form of volatile or non-volatile memory including, without limitation, magnetic media, optical media, random access memory (RAM), read-only memory (ROM), removable media, or any other suitable local or remote memory component. Memory 614 may store any suitable information to implement features of various embodiments, such as the address associated with an endpoint. The result of the interpretation done by processor 611 may include data related to a destination address (e.g., a phone number), a command for IP phone 610 to execute (e.g., to place the current communication session on hold) or a command to be sent to TPC 620.

With the exception of commands for IP phone 610, once the keystroke or set of keystrokes has been interpreted the resulting message/communication may be sent to the appropriate location through network 650 via interface 615. More specifically, where the user uses keypad 613 to enter a telephone number, IP phone 610 may then send the requisite signaling through network 650 to establish a call with the endpoint associated with the telephone number entered by the user. Where the user uses keypad 613 to enter a command for telepresence system 600, such as to mute the local microphones, IP phone 610 may send the request to mute the local microphones to TPC 620 which may then cause the local microphones to be muted. Another command the user may send to TPC 620 may be a request to transfer a particular user to/from a particular monitor 640. IP phone 610 may send the request TPC 620 which may then alter the outputed video and audio signals so as to accommodate the change requested by the user.

TPC 620 may include interfaces 621 and 622, memory 623, and processor 625. Interfaces 621 and 622 couple TPC 620 with network 650 and various components of telepresence system 600, respectively. Interfaces 621 and 622 may be operable to send and receive communications and/or control signals to and from endpoints 660 and/or any other components coupled to network 650 and/or TPC 620. Processor 625 may be a microprocessor, controller, or any other suitable computing device, resource, or combination of hardware, software and/or encoded logic. Processor 625 may be similar to or different than processor 611 of IP phone 610. Memory 614 may be any form of volatile or non-volatile memory including, without limitation, magnetic media, optical media, random access memory (RAM), read-only memory (ROM), removable media, or any other suitable local or remote memory component. Memory 614 may store any suitable information to implement features of various embodiments. Memory 614 may be similar to or different than memory 614 of IP phone 610.

These components may be interconnected so as to provide the functionality of TPC 620, such as providing IP phone 610 with the appropriate data. More specifically, some combination of processor 625 and memory 623 may be used to determine what display screen should be presented on screen 612 of IP phone 610. The necessary data for that display screen may be retrieved from memory 623 and relayed to IP phone 610 through network 650 via interface 621. Another function provided by TPC 620 may be to receive and execute commands from IP phone 610. More specifically, commands from IP phone 610 may be received via interface 621 and passed on to some processor 625. Processor 625 may then process the command and based on information that may be contained within memory 623 begin to execute the command.

Depending on the command, executing the command may entail making performance, quality or enabled feature modifications to a visual conferencing component such as monitors 640, cameras 630 and/or any other components of the telepresence system that may be coupled to TPC 620. For example, the command may include any of the requests listed above.

The present invention contemplates great flexibility in the arrangement and design of elements within a telepresence system as well as their internal components. Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A system for controlling a telepresence system, comprising:
a plurality of visual conferencing components operable to host a visual conference;
a controller coupled to the visual conferencing components; and
an internet protocol (IP) phone coupled to the controller and operable to display a user interface comprising a plurality of options and to receive input from a user and to relay the input to the controller, wherein the controller is operable to control the visual conferencing components in accordance with the input from the IP phone.

2. The system of claim 1, wherein the input comprises a request to establish an audio communication session with a remote endpoint using the IP phone during the visual conference.

3. The system of claim 1, wherein the input comprises a request to establish a subsequent video communication session with a remote endpoint using the IP phone during the visual conference.

4. The system of claim 1, wherein the input comprises a request to include video in an audio communication session.

5. The system of claim 1, wherein the input comprises a request to answer an incoming request for an audio communication session during the visual conference.

6. The system of claim 1, wherein the input comprises a request to answer an incoming request for a video communication session during the visual conference.

7. The system of claim 1, wherein the input comprises a request to prevent an incoming request for a communication session from being connected during the visual conference.

8. The system of claim 1, wherein:
the plurality of visual conferencing components comprises a plurality of displays; and
the input comprises a request to control which display of the plurality of displays will display video and which display of the plurality of displays will display data.

9. The system of claim 1, wherein the IP phone is further operable to provide information about a communication session while the user is involved in the visual conference.

10. The system of claim 9, wherein the information comprises information selected from the group consisting of: a caller identification of a remote user in a visual conference, whether the visual conference is encrypted, whether the visual conference is muted, whether the communication session is a visual conference, whether the communication session is a video conference, whether the communication session is an audio conference, and the elapsed time of the visual conference.

11. The system of claim 1, wherein the input comprises a request to select an auxiliary input from a plurality of auxiliary inputs for receiving visual conferencing component input during the visual conference.

12. A method for controlling a telepresence system, comprising:
conducting a visual conference using at least one component of a plurality of visual conferencing components;
displaying a plurality of options on a user interface of an internet protocol (IP) phone coupled to a controller controlling the plurality of visual conferencing components;
receiving input from a user;
relaying the input to the controller; and
controlling the visual conferencing components in accordance with the input from the IP phone.

13. The method of claim 12, wherein receiving input from a user comprises receiving a request to establish an audio communication session with a remote endpoint using the IP phone during the visual conference.

14. The method of claim 12, wherein receiving input from a user comprises receiving a request to establish a subsequent video communication session with a remote endpoint using the IP phone during the visual conference.

15. The method of claim 12, wherein receiving input from a user comprises receiving a request to include video in an audio communication session.

16. The method of claim 12, further comprising providing information about a communication session while the user is involved in the visual conference.

17. The method of claim 12, wherein receiving input from a user comprises receiving a request to select an auxiliary input from a plurality of auxiliary inputs for receiving visual conferencing component input during the visual conference.

18. Logic embodied in a computer readable medium, the computer readable medium comprising code operable to:
conduct a visual conference using at least one component of a plurality of visual conferencing components;
display a plurality of options on a user interface of an internet protocol (IP) phone coupled to a controller controlling the plurality of virtual conferencing components;
receive input from a user;
relay the input to the controller; and
control the visual conferencing components in accordance with the input from the IP phone.

19. The medium of claim 18, wherein the code operable to receive input from a user comprises code operable to receive a request to establish an audio communication session with a remote endpoint using the IP phone during the visual conference.

20. The medium of claim 18, wherein the code operable to receive input from a user comprises code operable to receive a request to establish a subsequent video communication session with a remote endpoint using the IP phone during the visual conference.

21. The medium of claim 18, wherein the code operable to receive input from a user comprises code operable to receive a request to include video in an audio communication session.

22. The medium of claim 18, wherein the code is further operable to provide information about a communication session while the user is involved in the visual conference.

23. The medium of claim 18, wherein the code operable to receive input from a user comprises code operable to receive a request to select an auxiliary input from a plurality of auxiliary inputs for receiving visual conferencing component input during the visual conference.

24. A system for controlling a telepresence system, comprising:
means for conducting a visual conference using at least one component of a plurality of visual conferencing components;
means for displaying a plurality of options on a user interface of an internet protocol (IP) phone coupled to a controller controlling the plurality of virtual conferencing components;
means for receiving input from a user;
means for relaying the input to the controller; and
means for controlling the visual conferencing components in accordance with the input from the IP phone.
